(19) United States
(12) Patent Application Publication
(10) Pub. No.: US 2020/0369268 A1
(43) Pub. Date: Nov. 26, 2020

(54) VEHICLES AND SYSTEMS FOR PREDICTING ROAD AGENT BEHAVIOR BASED ON DRIVING STYLE

(71) Applicant: Toyota Research Institute, Inc., Los Altos, CA (US)

(72) Inventors: Stephen G. McGill, Broomall, PA (US); Guy Rosman, Newton, PA (US); Luke S. Fletcher, Cambridge, MA (US)

(73) Assignee: Toyota Research Institute, Inc., Los Altos, CA (US)

(21) Appl. No.: 16/416,923

(22) Filed: May 20, 2019

(51) Int. Cl. B60W 30/095; B60W 40/09

(52) U.S. Cl. CPC B60W 30/0953; B60W 40/09

(57) ABSTRACT

An embodiment takes the form of a method carried out by a vehicle. The vehicle identifies a characteristic of a road agent. Based on the identified characteristic, the vehicle determines a driving style of the road agent. The vehicle predicts a behavior of the road agent based on the determined driving style.

### TECHNICAL FIELD

The present disclosure generally relates to vehicles and methods carried out by vehicles, and more specifically, to vehicles and methods for predicting a behavior of a road agent based on a determined driving style of the road agent.

### BACKGROUND

Vehicles are often equipped with a driver-assistance system, which may be able to aid a driver of the vehicle by providing functions such as adaptive cruise control, lane departure warnings, lane centering, and collision avoidance. Many of these features operate to prevent accidents or collisions with road agents, such as other vehicles, bicyclists, or other entities that may be sharing a road with the vehicle. Operation of these features may depend on a predicted trajectory of a given road agent. However, existing systems may not adequately predict such trajectory.

### SUMMARY

An embodiment of the present disclosure takes the form of a method carried out by a vehicle. The vehicle identifies a characteristic of a road agent. Based on the identified characteristic, the vehicle determines a driving style of the road agent. The vehicle predicts a behavior of the road agent based on the determined driving style.

Another embodiment takes the form of a vehicle that includes a processor and a non-transitory computer-readable storage medium that includes instructions. The instructions, when executed by the processor, cause the vehicle to identify a characteristic of a road agent and, based on the identified characteristic, determine a driving style of the road agent. The instructions further cause the vehicle to predict a behavior of the road agent based on the determined driving style.

A further embodiment takes the form of a method carried out by a vehicle. The vehicle identifies a first characteristic of the road agent and determines an initial driving style of the road agent based on the identified first characteristic. Additionally, the vehicle identifies a second characteristic of the road agent and determines an updated driving style of the road agent based on the identified first characteristic and the identified second characteristic. The vehicle predicts a behavior of the road agent based on the determined updated driving style.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIGS. 1a and 1b depict example scenarios in which operations of an ego vehicle may be carried out, according to one or more embodiments described and illustrated herein;

FIG. 2 depicts a block diagram of an ego vehicle, according to one or more embodiments described and illustrated herein;

FIG. 3 depicts example modules of an ego vehicle, according to one or more embodiments described and illustrated herein;

FIG. 4 depicts a flowchart of a method carried out by an ego vehicle, according to one or more embodiments described and illustrated herein.

FIG. 5 depicts a flowchart of a method in which an ego vehicle determines a driving style of a road agent based on two identified characteristics of the road agent, according to one or more embodiments described and illustrated herein;

FIG. 6 depicts a flowchart of a method in which an ego vehicle predicts a behavior of a road agent based on an updated driving style of the road agent, according to one or more embodiments described and illustrated herein; and

FIG. 7 depicts a flowchart of a method in which an ego vehicle predicts a second behavior of a road agent based on an updated driving style of the road agent, according to one or more embodiments described and illustrated herein.

### DETAILED DESCRIPTION

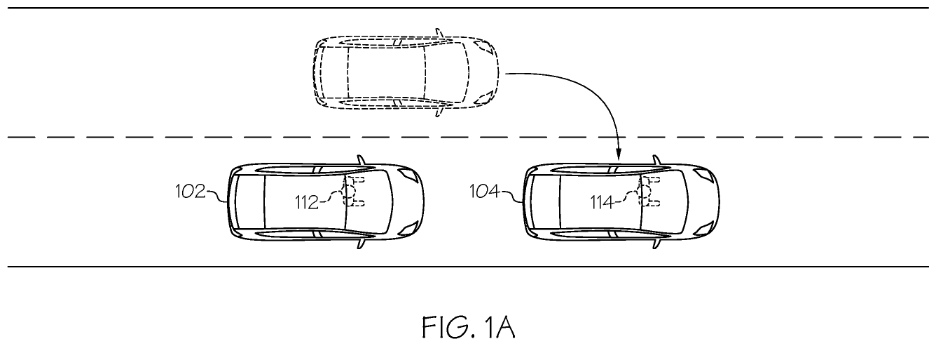

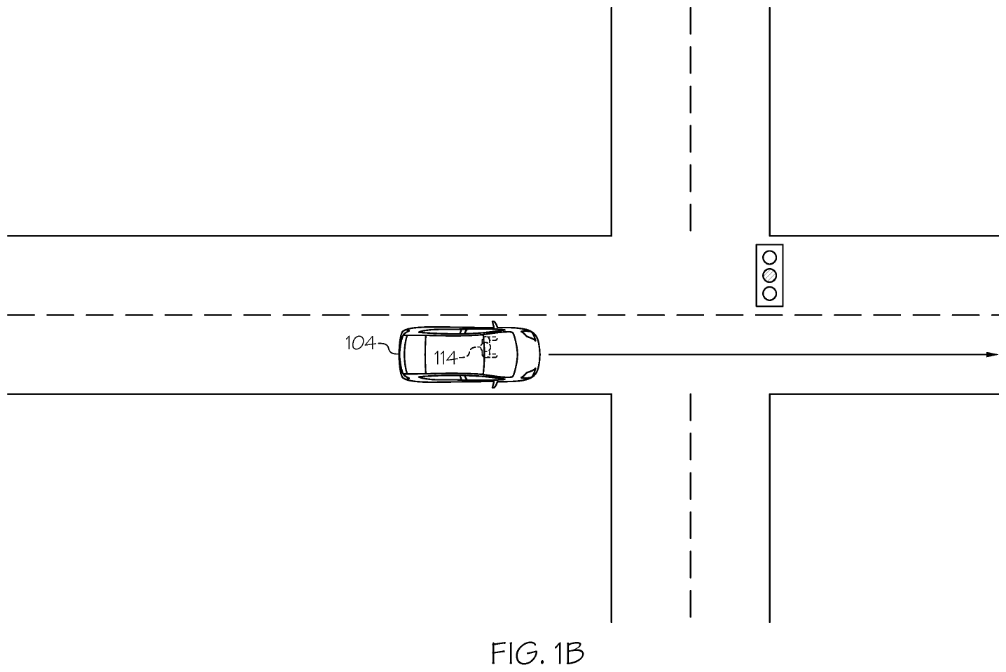

FIGS. 1a and 1b depict example scenarios in which operations of an ego vehicle may be carried out, according to one or more embodiments described and illustrated herein.

In the scenario shown in FIG. 1a, an ego vehicle 102 (also referred to as vehicle 102) is initially traveling on a highway in a straight direction in a right lane. A road agent 104, depicted as another vehicle, is initially traveling alongside the vehicle 102 in a left lane. The vehicle 102 and the road agent 104 have drivers 112 and 114, respectively. While both vehicles are still traveling forward, the road agent 104 quickly accelerates and changes lanes to the right lane directly in front of the vehicle 102, without signaling the lane change using a blinker, and leaving little distance between the front end of the vehicle 102 and the rear end of the road agent 104. The vehicle 102 identifies these behaviors of the road agent 104 using sensors provided on the vehicle (e.g., lidar or a camera), and based on the behaviors, the vehicle 102 determines that the driving style of the road agent is “aggressive,” since these behaviors are consistent with aggressive driving.

In the scenario shown in FIG. 1b, the vehicle 102 (not shown) is approaching an intersection with a stop light. The vehicle 102 determines that the road agent 104 is also approaching the intersection, and that the yellow light of the stop light is illuminated (e.g., based on lidar and/or the camera). The vehicle 102 further determines that there is sufficient distance between the road agent 104 and the stop light for the road agent to come to a complete stop before entering the intersection. However, based on the determination that the driving style of the road agent 104 is aggressive, the vehicle 102 predicts that the road agent will not stop but will instead accelerate through the intersection, since accelerating through an intersection during a yellow light is consistent with aggressive driving.

The vehicle 102 could take the form of an autonomous vehicle, a semi-autonomous vehicle, or a manually-operated vehicle (for example, in the form of an automobile, as shown in FIG. 1a), among other possibilities. The road agent 104 could take the form of a vehicle such as an automobile (also illustrated in FIGS. 1a and 1b), a bicycle, or a pedestrian, as examples. The road agent 104 may be in proximity to the vehicle 102—for example, in such a proximity that one or more sensors of the vehicle (such as lidar or a camera) can identify a characteristic (such as a behavior) of the road agent. The road agent 104 could be present on a road, a parking lot, a garage, or a sidewalk, as just a few possibilities, and the road agent could be moving or stationary. If the road agent 104 takes the form of a vehicle, then the road agent may have a driver. For example, as shown in FIGS. 1a and 1b, the road agent 104 has driver 114. If the road agent 104 takes the form of a bicycle, then the driver could take the form of a bicyclist riding the bicycle. The vehicle 102 and/or the road agent 104 could take other forms as well without departing from the scope of the disclosure.

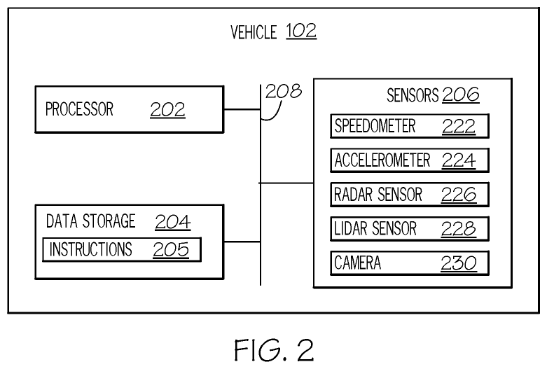

FIG. 2 depicts a block diagram of an ego vehicle, according to one or more embodiments described and illustrated herein. As shown, the vehicle 102 includes a processor 202, a data storage 204, and sensors 206, each of which are communicatively connected by a communication path 208. It should be understood that the vehicle 102 may include different and/or additional components, and some or all of the functions of a given component could instead be carried out by one or more different components.

The processor 202 may be any device capable of executing computer-readable instructions 205 stored in the data storage 204. The processor 202 may take the form of a general purpose processor (e.g., a microprocessor), a special purpose processor (e.g., an application specific integrated circuit), an electronic controller, an integrated circuit, a microchip, a computer, or any combination of one or more of these, and may be integrated in whole or in part with the data storage 204 or any other component of the vehicle 102, as examples.

The data storage 204 may take the form of a non-transitory computer-readable storage medium capable of storing the instructions 205 such that the instructions can be accessed and executed by the processor 202. As such, the data storage 204 may take the form of RAM, ROM, a flash memory, a hard drive, or any combination of these, as examples. The instructions 205 may comprise logic or algorithm(s) written in any programming language of any generation (e.g., 1GL, 2GL, 3GL, 4GL, or 5GL) such as, for example, machine language that may be directly executed by the processor 202, or assembly language, object-oriented programming (OOP), scripting languages, microcode, etc., that may be compiled or assembled into machine readable instructions and stored in the data storage 204. Alternatively, the instructions 205 may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single data storage 204, other embodiments may include more than one.

The sensors 206 could take the form of one or more sensors operable to detect information for use by the vehicle 102, including information regarding the road agent 104, the environment of the vehicle 102, and operation of the vehicle 102, as examples. Though the sensor 206 may at times be referenced in the singular throughout this disclosure, those of skill in the art will appreciate that the sensor 206 may take the form of (or include) a single sensor or multiple sensors. In the embodiment illustrated in FIG. 2, the sensor 206 include a speedometer 222, an accelerometer 224, a radar sensor 226, a lidar sensor 228, and a camera 230. The sensors may be positioned anywhere on the vehicle, including an interior of the vehicle 102 and/or an exterior of the vehicle. In some embodiments, the sensors are configured to detect information continuously—for example, in real-time such that information can be provided to one or more components of the vehicle 102 with little or no delay upon detection of the information by the sensor or upon a request for the detected information from a component of the vehicle. Those of skill in the art will appreciate that the sensor 206 may take other forms as well.

The speedometer 222 and the accelerometer 224 may be used to detect a speed and an acceleration of the vehicle 102, respectively. The radar sensor 226, the lidar sensor 228, and/or the camera 230 may be mounted on an exterior of the vehicle 102 and may obtain signals (such as electromagnetic radiation) that can be used by the vehicle to obtain information regarding the road agent 104 and/or other objects in the environment of the vehicle. For example, the radar sensor and/or the lidar sensor may send a signal (such as pulsed laser light or radio waves) and may obtain a distance measurement from the sensor to the surface of the road agent 104 or other object based on a time of flight of the signal—that is, the time between when the signal is sent and when the reflected signal (reflected by the object surface) is received by the sensor. The camera may collect light or other electromagnetic radiation and may generate an image representing a perspective view of the road agent 104 or the environment of the vehicle 102 based on the collected radiation. The obtained signals and/or generated image can be used by the vehicle to, for example, determine the presence, location, or trajectory of the road agent 104.

The communication path 208 may be formed from any medium that is capable of transmitting a signal—for example, conductive wires, conductive traces, optical waveguides, or the like. The communication path 208 may also refer to the expanse in which electromagnetic radiation and their corresponding electromagnetic waves traverses. Moreover, the communication path 208 may be formed from a combination of mediums capable of transmitting signals. In one embodiment, the communication path 208 comprises a combination of conductive traces, conductive wires, connectors, and buses that cooperate to permit the transmission of electrical data signals to and from the various components of the vehicle 102. Accordingly, the communication path 208 may comprise a bus. Additionally, it is noted that the term “signal” means a waveform (e.g., electrical, optical, magnetic, mechanical or electromagnetic) capable of traveling through a medium such as DC, AC, sinusoidal-wave, triangular-wave, square-wave, vibration, and the like.

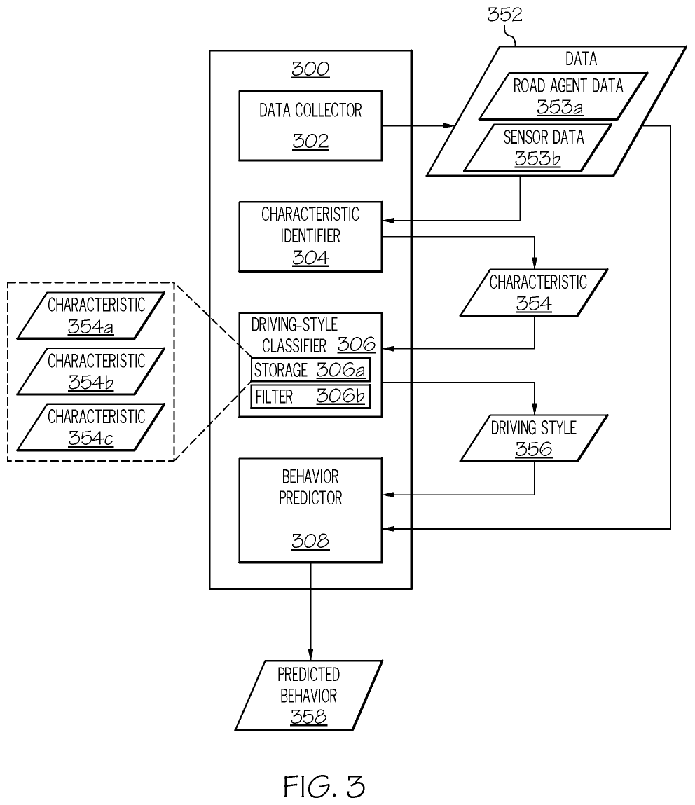

FIG. 3 depicts example modules of the vehicle 102, according to one or more embodiments described and illustrated herein. As shown, modules 300 of the vehicle 102 includes a data collector 302, a characteristic identifier 304, a driving-style classifier 306, and a behavior predictor 308. The modules may take the form of one or more hardware modules such as one or more electronic control units (ECUs), one or more software modules such as the instructions 205 executed by the processor 202, or any combination of these, as examples. Some or all the modules could be combined into a single module, and some or all of the functions of a given module could instead be carried out by one or more different modules. A summary of the operations performed by the modules is provided below, and additional details regarding the operations are described throughout this disclosure.

The data collector 302 could take the form of the data storage 204, the sensor 206, or any combination of these or other entities of the vehicle 102, and may operate to obtain data 352 for identifying a characteristic of the road agent 104 or predicting a behavior of the road agent, among other possibilities. For instance, the data storage 204 may include vendor-provided, previously-determined characteristics of road agents and respective driving styles associated with the characteristics, and the data collector 302 may obtain the previously-determined characteristics and associated driving styles from the data storage. As another possibility, the data collector 302 may obtain sensor data received via the sensor 206, such as radar data received via the radar sensor 226 or an image received via the camera 230.

In turn, the data 352 could take the form of (or include) data for use by the characteristic identifier 304, the driving-style classifier 306, the behavior predictor 308, or any other module or component of the vehicle 102. As shown, the data 352 could include road agent data 353a regarding the road agent 104, sensor data 353b received via the sensor 206, road agent data regarding the road agent received via the sensor, or any combination of these or other data. For example, the sensor 206 could take the form of the camera 230, and one or both of the road agent data 353a and the sensor data 353b could include data representing an image of the road agent 104. As another possibility, the sensor 206 could take the form of the radar sensor 226 or the lidar sensor 228, and one or both of the road agent data 353a and the sensor data 353b could include data representing a position, speed, or acceleration of the road agent 104.

The data 352, the road agent data 353a, and the sensor data 353b could take other forms as well, and any of the data, the road agent data, and the sensor data could be stored in the data storage 204, for example.

The characteristic identifier 304 may operate to identify a characteristic 354 of a road agent—e.g., based on data obtained by the data collector 302. For instance, if the road agent 104 takes the form of a vehicle, then the characteristic 354 could include a characteristic of the vehicle, such a color of the vehicle, a make of the vehicle, a model of the vehicle, or any combination of these or other characteristics of a vehicle, as examples. As another possibility, if the road agent 104 has a driver 114, then the characteristic 354 could include a characteristic of the driver. For example, the characteristic of the driver 114 could take the form of an age of the driver, a visual acuity of the driver, a blood alcohol content of the driver, or any combination of these or other characteristics of a driver. The characteristic of the road agent 104 (including a driver 114 of the road agent) could take other forms without departing from the scope of the disclosure.

The characteristic 354 could take the form of a behavior of the road agent 104. For example, the behavior of the road agent 104 could take the form of a sudden acceleration, a sudden deceleration, speeding, running a stop light, running a stop sign, a cut-in, a lane change without indicating via a blinker, multiple lane changes in a short period of time, a pass in an improper lane, swerving within a lane, swerving between lanes, tailgating, honking a horn of the road agent, flashing headlights of the road agent, or any combination of these or other behaviors of a road agent. Additionally or alternatively, the behavior of the road agent 104 could take the form of a trajectory of the road agent. The trajectory could be a discrete, categorized trajectory such as a turn, a lane change, an acceleration, a deceleration, or a stop, as examples. Or the trajectory could take the form of a trajectory that does not fall within a category. The behavior of the road agent 104 could take other forms as well.

If the road agent 104 has a driver 114, then the behavior of the road agent 104 could take the form of a behavior of the driver of the road agent. For example, the behavior of the driver 114 could include operating a cell phone, talking on a cell phone, texting via a cell phone, operating a center console display of the road agent 104, talking to a passenger of the road agent, eating food, drinking a beverage, or any combination of these or other observed behaviors of a driver.

The driving-style classifier 306 may operate to determine a driving style 356 of the road agent 104 based on the characteristic 354 identified by the characteristic identifier 304. The driving style 356 could be, for example, aggressive, calm, determined, passive, distracted, or a combination of these or other styles. Moreover, the driving style 356 need not take the form of a discrete, categorized driving style. The driving-style classifier 306 may be trained to determine the driving style 356 based on previously-determined characteristics of road agents and respective driving styles associated with the previously-determined characteristics. For example, the driving-style classifier 306 may be trained using machine-learning techniques (for instance, by a vendor before the vehicle 102 is delivered to a customer).

The driving-style classifier 306 may include a characteristic storage 306a to store one or more characteristics identified by the characteristic identifier 304. For instance, the characteristic storage 306a take the form of (or include) the data storage 204 and may store one or more characteristics 354a, 354b, and 354c identified by the characteristic identifier 304. The characteristic storage 306a may further store one or more timestamps or other metadata associated with respective characteristics in the characteristic storage. The driving-style classifier 306 may determine the driving style 356 based on any one or more of the characteristics 354, 354a, 354b, and/or 354c, as examples. Additionally, the driving-style classifier 306 may include a smoothing filter 306b that may be applied by the vehicle 102 to any two or more identified characteristics of the road agent 104 such as characteristics 354, 354a, 354b, and/or 354c. For example, the vehicle 102 may apply the smoothing filter 306b to characteristics 354, 354a, 354b, and/or 354c before determining a driving style based on the characteristics. Applying the smoothing filter 306b may prevent extreme and/or sudden differences between an initially-determined driving style and a subsequently-determined driving style. Example smoothing filters include a moving-average algorithm and an exponential smoothing algorithm, among other possibilities.

The behavior predictor 308 may operate to predict a behavior 358 of the road agent 104 based on the driving style 356 of the road agent determined by the driving-style classifier 306. In some embodiments (such as the embodiment shown in FIG. 3), the behavior predictor 308 may predict the behavior 358 based on both the driving style 356 and the data 352 obtained by the data collector 302.

The predicted behavior 358 could take the form of, for example, one or more of the behaviors discussed above with reference to the characteristic 354, such as a sudden acceleration or a cut-in by the road agent 104, or the driver 114 drinking a beverage, among other possibilities. For instance, the predicted behavior 358 could take the form of a predicted trajectory of the road agent 104, and the vehicle 102 may predict the trajectory based on data received via the radar sensor 226 or the lidar sensor 228, and based on the driving style 356.

Any of the data 352, the characteristic 354, the driving style 356, and predicted behavior 358 could be represented by a message (or combination of messages) that is sent to and/or received from another module or component of the vehicle 102. The message could take the form of one or more packets, datagrams, data structures, other data, or any combination of these or other messages. It should be understood, however, that the data 352, the characteristic 354, the driving style 356, and the predicted behavior 358 need not take the form of a discrete message or data.

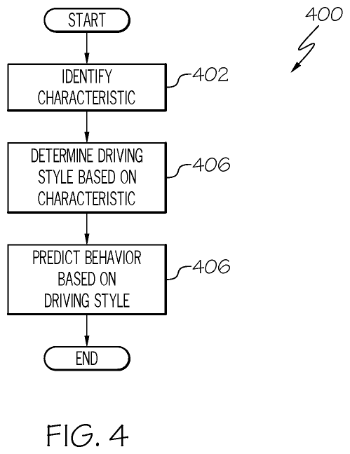

FIG. 4 depicts a flowchart of a method carried out by the vehicle 102, according to one or more embodiments described and illustrated herein. As shown, a method 400 begins at step 402 with the vehicle 102 identifying a characteristic 354 of a road agent 104. Identifying the characteristic 354 of the road agent 104 could include identifying a characteristic of a driver 114 of the road agent 104, and/or could include identifying multiple characteristics of the road agent. In an embodiment, the vehicle 102 identifying the characteristic 354 takes the form of (or includes) the characteristic identifier 304 identifying the characteristic.

In an embodiment, identifying the characteristic 354 includes identifying the characteristic based on data 352. If the data 352 includes road agent data 353a regarding the road agent 104, then identifying the characteristic 354 could include identifying the characteristic based on the road agent data. If the data 352 includes sensor data 353b received via the sensor 206, then identifying the characteristic 354 could include identifying the characteristic based on the sensor data. For example, if sensor data 353b includes data received via the camera 230 representing an image of the road agent 104, then the vehicle 102 may identify a characteristic 354 such as a color, make, or model of the road agent (if the road agent is a vehicle) based on the image. If the road agent 104 has a driver 114 and the sensor data 353b includes data representing an image of the driver, then the vehicle 102 may identify a characteristic 354 of the driver such as an age of the driver based on the image.

Identifying the characteristic 354 of the road agent 104 could include identifying a behavior of the road agent based on the data 352 (including road agent data 353a and the sensor data 353b). For example, if the road agent 104 takes the form of another vehicle and the sensor data 353b includes data representing a position, speed, or acceleration of the other vehicle (e.g., received via the radar sensor 226 or the lidar sensor 228), then the vehicle 102 may identify a behavior of the road agent, such as a sudden acceleration or a cut-in, based on the sensor data. If the road agent 104 has a driver 114 and the sensor data 353b includes data representing an image of the road agent (e.g., received via the camera 230), then the vehicle 102 may identify a behavior of the driver (such as talking on a cell phone) based on the image.

At step 404, the vehicle 102 determines a driving style 356 of the road agent 104 based on the characteristic 354 of the road agent 104 identified at step 402. As one possibility, the vehicle may compare the characteristic 354 of the road agent 104 with previously-determined characteristics of road agents, whether determined by the vehicle 102, a different vehicle, a vehicle vendor, or another entity. The previously-determined characteristics (and respective driving styles associated with the previously-determined characteristics) could be stored in data the storage 204, for instance, and could be provided by a vendor before the vehicle 102 is delivered to a customer, among other examples. The vehicle 102 may determine that the characteristic 354 of the road agent 104 is similar to a previously-determined characteristic, and may determine a driving style 356 of the road agent 104 based on the driving style associated with the similar characteristic (even if the determined or similar driving styles are not discrete, categorized types of driving style). As another possibility, if the driving-style classifier 306 is trained (e.g., using machine-learning techniques) based on previously-determined characteristics of road agents and respective driving styles associated with the previously-determined characteristics, then the vehicle 102 may determine the driving style 356 of the road agent 104 using the trained driving-style classifier. The driving style 356 determined using the trained driving-style classifier may, but need not, be a discrete, categorized driving style. In an embodiment, the vehicle 102 determining the driving style 356 takes the form of (or includes) the driving-style classifier 306 determining the driving style.

Numerous examples of determining the driving style 356 based on the characteristic 354 are possible. For instance, if the road agent 104 is a vehicle and the identified characteristic 354 is that the color of the vehicle is red, then based on this characteristic, the vehicle 102 may determine that the driving style 356 of the road agent is aggressive, since red vehicles may be associated with aggressive driving. If the characteristic 354 is that the road agent 104 is a minivan (instead of a sport utility vehicle or coupe, for instance), then the vehicle 102 may determine that the driving style 356 of the road agent is passive, since minivans may be associated with passive driving. If the identified characteristic 354 is that the road agent 104 has changed lanes without indicating via a blinker, then based on this characteristic (in this case, a behavior of the road agent), the vehicle 102 may determine that the driving style 356 of the road agent is aggressive or distracted, since this behavior may be associated with aggressive or distracted driving. If the identified characteristic 354 is that a driver 114 of the road agent 104 is operating a center console display of the road agent, then based on this characteristic (in this case, a behavior of a driver of the road agent), the vehicle 102 may determine that the driving style 356 of the road agent is distracted, since this behavior of a driver may be associated with distracted driving.

At step 406, the vehicle 102 predicts a behavior 358 of the road agent 104 based on the driving style 356 determined at step 404. For example, with reference to FIG. 1b, the vehicle 102 may predict that the road agent 104 will accelerate through the intersection (rather than stopping before entering the intersection) based on the determination that the driving style 356 of the road agent 104 is aggressive. In an embodiment, the vehicle 102 predicting the behavior 358 of the road agent 104 takes the form of (or includes) the behavior predictor 308 predicting the behavior.

The vehicle 102 may predict the behavior 358 of the road agent 104 based on data 352 (in addition to the driving style 356). If at step 402, the vehicle 102 identifies the characteristic 354 based on the data 352, then at step 406, portions of the data used to identify the characteristic may be the same as or different from portions of the data used to predict the behavior 358. For example, the sensor data 353b may include data received via the radar sensor 226, the lidar sensor 228, and the camera 230. The vehicle 102 may identify the characteristic 354 of the road agent 104 based on the data received via the radar sensor 226 and the camera 230, but not based on the data received via the lidar sensor 228. The vehicle 102 may predict the behavior 358 of the road agent 104 based on the driving style 356 (which in turn is determined based on the characteristic 354) and the data received via the lidar sensor 228 and the camera 230, but not based on the data received via the radar sensor 226.

The vehicle 102 may predict the behavior 358 of the road agent 104 based on one or more features (e.g., properties) represented in the data 352. A feature could represent, for example, a number of road agents in the vicinity of the vehicle 102, a position, speed, or trajectory of a road agent, a speed limit or number of lanes of a road on which the vehicle 102 or a road agent is traveling, or any combination of these or other features. The portions of the data 352 upon which the predicted behavior 358 is based may depend on the features upon which the prediction of behavior 358 is based. For example, if the vehicle 102 predicts the behavior 358 based on a trajectory of the road agent 104, then the vehicle 102 may predict the behavior based on data received via the radar sensor 226 or the lidar sensor 228, but not based on data received via the camera 230.

At step 402, identifying the characteristic 354 of the road agent 104 may include identifying the characteristic based on one or more features (such as a set of one or more features) represented in the road agent data 353a. The characteristic 354 in turn may take the form of (or include) respective values of the features. For example, a feature represented in the road agent data 353a could take the form of a color of the road agent 104, and the characteristic 354 could take the form of (or include) a value of “red” for this feature.

At step 406, the features upon which the prediction of the behavior 358 is based may differ from the features upon which the identification of the characteristic 354 is based. For example, the vehicle 102 may identify the characteristic 354 of the road agent 104 based on the color feature of the road agent described above, and may predict the behavior 358 of the road agent 104 based on a trajectory feature (e.g., a trajectory of the road agent) represented in the data 352 and further based on the driving style 356 of the road agent 104.

However, even if the features used for the prediction of the behavior 358 differ from the features used for the identification of the characteristic 354, the prediction of the behavior 358 may still be affected by the features upon which the identification of the characteristic 354 is based. For example, even though the vehicle 102 may predict the behavior 358 based on a set of features that does not include the color feature, the prediction is nevertheless based on the driving style 356, which is determined based on the characteristic 354 (which in turn may be identified based on the color characteristic).

The vehicle 102 may predict the behavior 358 of the road agent 104 according to a given prediction topology. For example, the vehicle 102 may predict the behavior 358 of the road agent 104 according to a topology for predicting a trajectory of the road agent, a discrete turn of the road agent, a steering of the road agent, an acceleration of the road agent, an interaction between the road agent and a second road agent, and/or any combination of these or other topologies. As one possibility, if the road agent 104 is at an intersection, then the vehicle 102 could predict the behavior 358 according to a topology for predicting a discrete turn. As another possibility, if other road agents are in the vicinity of the road agent 104, then the vehicle 102 could predict the behavior 358 according to a topology for predicting an interaction between road agents. The topology according to which the vehicle 102 predicts the behavior 358 may be based on a context of the vehicle 102 (e.g., determined based on sensor data received via the sensor 206). The context of the vehicle 102 could include (or take the form of) a context of the road agent 104. For instance, if the context is that the road agent 104 is approaching an intersection, then based on this context, the vehicle 102 may predict the behavior 358 based on a topology for predicting a discrete turn.

A given set of one of more features may be associated with a respective topology, and predicting the behavior 358 of the road agent 104 according to the respective topology may include predicting the behavior based on one or more features associated with the respective topology. For example, a numerosity feature could take the form of a number of road agents in the vicinity of the vehicle 102. The numerosity feature could be associated with an interaction topology for predicting an interaction between the road agent 104 and the vehicle 102 or between the road agent 104 and one or more other road agents. If the vehicle 102 predicts the behavior 358 of the road agent 104 according to the interaction topology, then the vehicle 102 may predict the behavior based on the numerosity feature. As another example, the color feature described above could be associated with an acceleration topology for predicting an acceleration of the road agent 104. If the vehicle 102 predicts the behavior 358 of the road agent 104 according to the acceleration topology, then the vehicle 102 may predict the behavior based on the color feature

Before predicting the behavior 358 of the road agent 104 at step 406, the vehicle 102 may make a prior prediction of a behavior of the road agent 104. To make this prediction, the vehicle 102 may obtain data 352 (such as road agent data 353a and sensor data 353b), and the vehicle may make the prior prediction based on this previously-obtained data. The vehicle may make the prior prediction according to a given (prior) topology, and the data 352 then obtained by the vehicle 102 may depend on the topology used for the prediction. At step 402, the vehicle 102 may identify the characteristic 354 based on the previously-obtained data, and at step 404, the vehicle may determine the driving style 356 based on the identified characteristic.

Subsequently, at step 406, the vehicle 102 may again obtain data 352, and predicting the behavior 358 may include predicting the behavior based on the driving style 356 and the subsequently-obtained data. The vehicle may make this subsequent prediction according to a given (subsequent) topology, and the data 352 obtained by the vehicle 102 may depend on the topology used for this prediction.

The subsequent topology used to make the subsequent prediction at step 406 may differ from the prior topology used to make the prior prediction, and the subsequently-obtained data may differ from the previously-obtained data. Since respective sets of features may be associated with the topologies, the features used to make the subsequent and prior predictions may differ. Even if a given feature, such as a trajectory of the road agent 104, is used to make both predictions, the value of the feature when making the subsequent prediction may differ from the value of the feature when making the prior prediction (e.g., since the subsequent prediction may be based subsequently-obtained data different from the previously-obtained data). For example, a trajectory feature may take the form of a trajectory of the road agent 104. The vehicle 102 may make the prior prediction based on a “left-turn” value of the trajectory feature (e.g., based on a left turn of the road agent 104), and may make the subsequent prediction based on a “right-turn” value of the trajectory feature. Additionally, since the vehicle 102 may identify the characteristic 354 based on the previously-obtained data, the data used to identify the characteristic at step 402 may differ from the data (e.g., the subsequently-obtained data) used make the prediction at step 406. Similarly, the features (and/or the values of the features) used to identify the characteristic 354 at step 402 may differ from the features (and/or values) used to make the prediction at step 406.

However, even if the topologies, features, and/or data used to make the subsequent prediction at step 406 may differ from those used to make the prior prediction, the prediction of the behavior 358 at step 406 may be affected by the data used to make the prior prediction (which, in this example, may include the same data used to identify the characteristic 354 at step 402). Moreover, even if the value of a feature used when making the prior prediction (and when identifying the characteristic) differs from the value of the same feature used when making the subsequent prediction, such that the subsequent prediction would be different (perhaps very different) if the prior value were used instead of the subsequent value, the prior and subsequent values of this feature may nevertheless be consistent with the driving style 356 determined at step 404.

Subsequent to any of steps 402, 404, and 406, the vehicle 102 may identify a second characteristic of the road agent 104. The second characteristic may be identified if, for example, the data collector 302 obtains additional data 352 regarding the road agent 104: the vehicle 102 may then identify the second characteristic based on the additional data. The vehicle may determine the driving style of the road agent 104 based on both the characteristic identified at step 402 and the identified second characteristic.

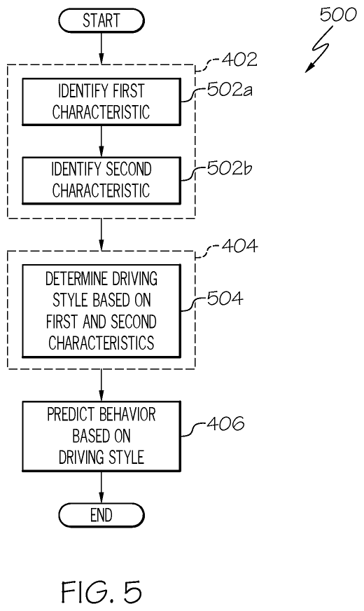

As an example, FIG. 5 depicts a flowchart of a method in which the vehicle 102 determines a driving style of the road agent 104 based on two identified characteristics of the road agent, according to one or more embodiments described and illustrated herein. As shown, a method 500 includes the steps 402, 404, and 406, discussed above with reference to FIG. 4. At step 402, identifying the characteristic 354 of the road agent 104 includes steps 502a and 502b. At step 502a, the vehicle 102 identifies a first characteristic of the road agent 104 and, at step 502b, the vehicle identifies a second characteristic of the road agent. At step 404, determining the driving style 356 of the road agent 104 based on the characteristic 354 includes, at step 504, determining the driving style based on the first characteristic identified at step 502a and the second characteristic identified at step 502b. At step 406, the vehicle 102 predicts the behavior 358 of the road agent 104 based on the driving style 356 determined at step 404.

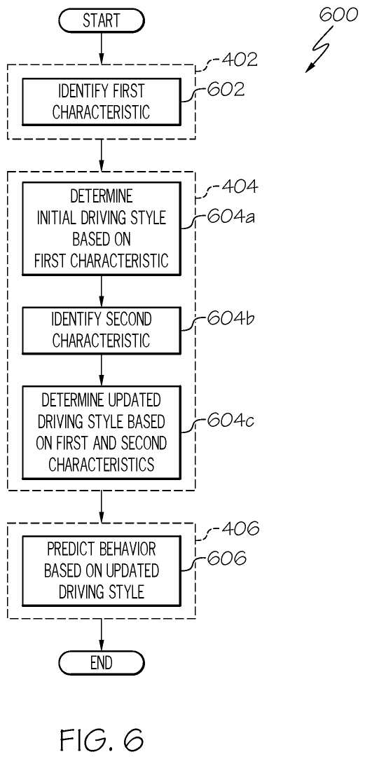

The vehicle 102 may determine an initial driving style of the road agent 104 based on the characteristic identified at step 402, and may subsequently determine an updated driving style based on the characteristic identified at step 402 and a second characteristic of the road agent 104 identified by the vehicle. The vehicle 102 may determine the updated driving style if, for example, the vehicle identifies the second characteristic after determining the initial driving style. The second characteristic may (but need not) be different from the characteristic identified at step 402, and the updated driving style may (but need not) be different from the initial driving style. To illustrate, FIG. 6 depicts a flowchart of a method in which the vehicle 102 predicts a behavior of the road agent 104 based on an updated driving style of the road agent, according to one or more embodiments described and illustrated herein. As shown, a method 600 includes the steps 402, 404, and 406, discussed above with reference to FIG. 4. At step 402, identifying the characteristic 354 of the road agent 104 includes, at step 602, the vehicle 102 identifying a first characteristic of the road agent. At step 404, determining the driving style 356 of the road agent 104 based on the characteristic 354 includes steps 604a, 604b, and 604c. At step 604a, the vehicle 102 determines an initial driving style of the road agent 104 based on the first characteristic identified at step 602. At step 604b, the vehicle 102 identifies a second characteristic of the road agent 104, and at step 604c, the vehicle determines an updated driving style of the road agent based on the first characteristic identified at step 602 and the second characteristic identified at step 604b. At step 406, predicting the behavior 358 of the road agent 104 based on the driving style 356 includes, at step 606, the vehicle 102 predicting the behavior of the road agent based on the updated driving style determined at step 604c. It will be understood by those of skill in the art that the second characteristic may be identified at step 604b before or after the initial driving style is determined at step 604a.

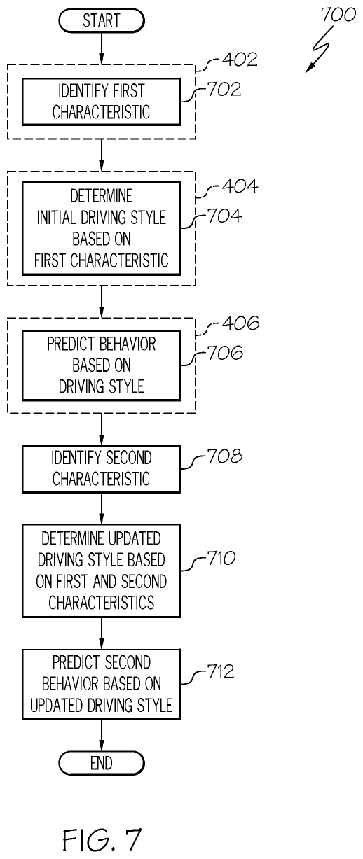

The vehicle 102 may predict a first behavior of the road agent 104 based on an initial driving style, and may subsequently predict a second behavior based on an updated driving style. As an example, FIG. 7 depicts a flowchart of a method in which the vehicle 102 predicts a second behavior of the road agent 104 based on an updated driving style of the road agent, according to one or more embodiments described and illustrated herein. As shown, a method 700 includes steps 402, 404, and 406, as discussed above with reference to FIG. 4. At step 402, identifying the characteristic 354 of the road agent 104 includes, at step 702, the vehicle 102 identifying a first characteristic of the road agent. At step 404, determining the driving style 356 of the road agent 104 based on the characteristic 354 includes, at step 704, the vehicle 102 determining an initial driving style of the road agent based on the first characteristic identified at step 702. At step 406, predicting the behavior 358 of the road agent 104 based on the driving style 356 includes, at step 706, the vehicle 102 predicting a first behavior of the road agent based on the initial driving style determined at step 704.

Method 700 further includes steps 708, 710, and 712. At step 708 (e.g., subsequent to predicting the first behavior of the road agent 104 at step 706), the vehicle 102 identifies a second characteristic of the road agent. At step 710, the vehicle 102 determines an updated driving style of the road agent 104 based on the first characteristic identified at step 702 and the second characteristic identified at step 708, and at step 712, the vehicle 102 predicts a second behavior of the road agent based on the updated driving style determined at step 710.

The vehicle 102 may store the identified first and second characteristics (or any other identified characteristics of the road agent 104) in the characteristic storage 306a, and may determine a driving style of the road agent based on any one or more characteristics stored in the characteristic storage. For example, with reference to FIG. 3, the characteristic identifier 304 may identify a first characteristic of the road agent 104, and the driving-style classifier 306 may determine an initial driving style based on the first characteristic. Additionally, the driving-style classifier 306 may store the first characteristic to the characteristic storage 306a as characteristic 354a. Subsequently, the characteristic identifier 304 may identify a second characteristic 354 of the road agent 104—for example, after obtaining additional sensor data 353b regarding the road agent—and the driving-style classifier 306 may determine an updated driving style based on the characteristic 354a and the identified second characteristic 354. As shown in FIG. 3, the characteristic storage 306a may store any number of identified characteristics (such as characteristics 354a, 354b, and 354c), and the driving-style classifier 306 may determine a driving style of the road agent 104 based on any one or more (or none) of the stored characteristics.

The vehicle 102 may continuously update the driving style 356 of the road agent 104—for instance, as additional characteristics of the road agent are identified. As one possibility, the vehicle 102 may determine the driving style 356 of the road agent 104 in response to determining a characteristic 354 of the road agent, or may update the driving style 356 in response to identifying one or more additional characteristics. As another possibility, the vehicle 102 may determine or update the driving style 356 of the road agent 104 according to a clock cycle of the processor 202 or an instruction cycle of the processor (for example, every ten hertz). The vehicle 102 may continuously update the driving style 356 according to any combination of these and/or other possibilities.

In some embodiments, the vehicle 102 may apply the smoothing filter 306b to the first and second characteristics identified in any of methods 500, 600, or 700, or to the characteristics identified in any other embodiment in which more than one characteristic of the road agent 104 is identified. Though the term “smoothing “filter” is used, those of skill in the art will understand that any smoothing algorithm or function may be applied by the vehicle 102 to the characteristics. The vehicle may apply the smoothing filter 306b before determining a driving style based on the characteristics—for example, so as to prevent extreme and/or sudden differences between an initial driving style and a subsequent driving style. For instance, in either of methods 600 or 700, determining the updated driving style based on the identified first and second characteristics may include the vehicle 102 applying a smoothing filter 306b to the characteristics before determining the updated driving style.

The vehicle may perform any of the steps 402, 404, and 406 based on a nature of the characteristic 354. For example, the characteristic 354 may take the form of a state of mind of the driver 114 of the road agent 104 (e.g., an attitude or mood such as angry or hurried). Because the state of mind of a driver can change in a relatively small amount of time and with relatively greater frequency, the vehicle 102 may identify additional characteristics (e.g., additional states of mind) and/or determine (e.g., update) the driving style with relatively greater frequency, and the smoothing filter 306b may be applied based on the relatively greater frequency. Conversely, the characteristic 354 may take the form of an age of the driver 114. Because the age of a driver won't change considerably during a given trip of the vehicle 102, the vehicle 102 may identify additional characteristics (e.g., updated driver ages) and/or determine the driving style with relatively lower frequency, and the smoothing filter 306b may be applied based on the relatively small change of age over time.

It should now be understood that embodiments described herein are directed to vehicles and methods for predicting a behavior of a road agent. The vehicle identifies a characteristic of the road agent and determines a driving style of the road agent based on the identified characteristic. The vehicle predicts the behavior of the road agent based on the determined driving style.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method carried out by an ego vehicle, the method comprising:
identifying a characteristic of a road agent;
determining a driving style of the road agent based on the identified characteristic; and
predicting a behavior of the road agent based on the determined driving style.

2. The method of claim 1, wherein the identified characteristic of the road agent comprises a behavior of the road agent.

3. The method of claim 1, wherein:
the road agent comprises a driver, and
the identified characteristic of the road agent comprises a characteristic of the driver.

4. The method of claim 1, wherein the determined driving style comprises at least one of aggressive, calm, determined, passive, and distracted.

5. The method of claim 1, wherein:
identifying the characteristic of the road agent comprises identifying a first characteristic of the road agent and identifying a second characteristic of the road agent;
determining the driving style of the road agent based on the identified characteristic comprises determining the driving style based on the identified first characteristic and the identified second characteristic.

6. The method of claim 5, further comprising:
before determining the driving style based on the identified first characteristic and the identified second characteristic, applying a smoothing filter to the identified first characteristic and the identified second characteristic.

7. The method of claim 1, wherein:
identifying the characteristic of the road agent comprises identifying a first characteristic of the road agent;
determining the driving style of the road agent based on the identified characteristic comprises:
determining an initial driving style of the road agent based on the identified first characteristic;
identifying a second characteristic of the road agent; and
determining an updated driving style of the road agent based on the identified first characteristic and the identified second characteristic, and
predicting the behavior of the road agent based on the determined driving style comprises predicting the behavior based on the determined updated driving style.

8. The method of claim 7, wherein determining the updated driving style of the road agent comprises determining the updated driving style in response to identifying the second characteristic of the road agent.

9. The method of claim 1, wherein:
identifying the characteristic of the road agent comprises identifying a first characteristic of the road agent,
determining the driving style of the road agent based on the identified characteristic comprises determining an initial driving style of the road agent based on the identified first characteristic, and
predicting the behavior of the road agent based on the determined driving style comprises predicting a first behavior of the road agent based on the determined initial driving style,
the method further comprising:
subsequent to predicting the first behavior of the road agent, identifying a second characteristic of the road agent;
determining an updated driving style of the road agent based on the identified first characteristic and the identified second characteristic; and
predicting a second behavior of the road agent based on the determined updated driving style.

10. The method of claim 1, further comprising:
subsequent to determining the driving style of the road agent, continuously updating the driving style of the road agent based on the identified characteristic of the road agent and subsequently identified characteristics of the road agent.

11. The method of claim 1, wherein:
identifying the characteristic of the road agent comprises identifying the characteristic based on a first set of one or more features represented in data obtained by the vehicle, and
predicting the behavior of the road agent comprises predicting the behavior based on both the determined driving style and a second set of one or more features represented in the data, and
the first set of features is different from the second set of features.

12. A method carried out by an ego vehicle, the method comprising:
identifying a first characteristic of a road agent;
determining an initial driving style of the road agent based on the identified first characteristic;
identifying a second characteristic of the road agent;
determining an updated driving style of the road agent based on the identified first characteristic and the identified second characteristic; and
predicting a behavior of the road agent based on the determined updated driving style.

13. The method of claim 12, further comprising:
before determining the updated driving style based on the identified first characteristic and the identified second characteristic, applying a smoothing filter to the identified first characteristic and the identified second characteristic.

14. The method of claim 12, wherein determining the updated driving style of the road agent comprises determining the updated driving style in response to identifying the second characteristic of the road agent.

15. A vehicle comprising:
a sensor;
a processor; and
a non-transitory computer-readable storage medium comprising instructions that, when executed by the processor, cause the vehicle to:
obtain sensor data via the sensor, wherein the sensor data comprises road agent data regarding a road agent;
identify a characteristic of a road agent based on a first set of one or more features represented in the road agent data;
determine a driving style of the road agent based on the identified characteristic; and
predict a behavior of the road agent based on (i) the determined driving style and (ii) a second set of one or more features represented in the road agent data,
wherein the first set of features is different from the second set of features.

16. The vehicle of claim 15, wherein:
the instructions that cause the vehicle to identify the characteristic of the road agent based on the first set of features comprise instructions that cause the vehicle to:
predict a first behavior of the road agent based on an initial set of one or more features represented in the road agent data; and
identify the characteristic of the road agent based on the initial set of features,
the instructions that cause the vehicle to predict the behavior of the road agent based on the determined driving style and the second set of features comprise instructions that cause the vehicle to predict a second behavior of the road agent based on the determined driving style and the second set of features, and
the initial set of features is different from the second set of features.

17. The vehicle of claim 16, wherein:
the instructions that cause the vehicle to identify the characteristic of the road agent based on the initial set of features comprise instructions that cause the vehicle to identify a first characteristic of the road agent based on the initial set of features,
the instructions that cause the vehicle to determine the driving style of the road agent based on the identified characteristic comprise instructions that cause the vehicle to:
determine an initial driving style of the road agent based on the identified first characteristic;
identify a second characteristic of the road agent; and
determine an updated driving style of the road agent based on the identified first characteristic and the identified second characteristic, and
the instructions that cause the vehicle to predict the second behavior of the road agent based on the determined driving style and the second set of features comprise instructions that cause the vehicle to predict the second behavior of the road agent based on the determined updated driving style and the second set of features.

18. The vehicle of claim 17, further comprising instructions that cause the vehicle to:
before determining the updated driving style based on the identified first characteristic and the identified second characteristic, apply a smoothing filter to the identified first characteristic and the identified second characteristic.

19. The vehicle of claim 16, wherein:
the initial set of features is associated with a first prediction topology,
the second set of features is associated with a second prediction topology,
the instructions that cause the vehicle to predict the first behavior of the road agent based on the initial set of features comprise instructions that cause the vehicle to predict the first behavior according to the first prediction topology, and
the instructions that cause the vehicle to predict the second behavior of the road agent based on the determined driving style and the second set of features comprise instructions that cause the vehicle to predict the second behavior of the road agent according to the second prediction topology.

20. The vehicle of claim 15, further comprising instructions that cause the vehicle to:
subsequent to determining the driving style of the road agent, continuously updating the driving style of the road agent based on the identified characteristic of the road agent and subsequently identified characteristics of the road agent.
